(19) United States
(12) Patent Application Publication
(10) Pub. No.: US 2013/0256260 A1
(43) Pub. Date: Oct. 3, 2013

(54) METHOD OF FORMING SUBSTRATE FOR FLUID EJECTION DEVICE

(71) Applicants: Siddhartha Bhowmik, Salem, OR (US); J. Daniel Smith, Corvallis, OR (US)

(72) Inventors: Siddhartha Bhowmik, Salem, OR (US); J. Daniel Smith, Corvallis, OR (US)

(21) Appl. No.: 13/822,050

(22) PCT Filed: Oct. 19, 2010
(86) PCT No.: PCT/US10/53190

§ 371 Date: Mar. 11, 2013

(51) Int. Cl. B41J 2/16

(52) U.S. Cl. CPC B41J 2/1629; B41J 2/1628
USPC 216/27

(57) ABSTRACT

A method of forming a substrate for a fluid ejection device includes forming an opening in the substrate from a second side of the substrate toward a first side of the substrate, further forming the opening in the substrate to the first side of the substrate, anisotropically wet etching the substrate, including increasing the opening at the second side of the substrate and forming the opening with converging sidewalls from the second side to the first side, and after anisotropically wet etching the substrate, isotropically etching the substrate.

### BACKGROUND

An inkjet printing system, as one embodiment of a fluid ejection system, may include a printhead, an ink supply which supplies ink to the printhead, and an electronic controller which controls the printhead. The printhead, as one embodiment of a fluid ejection device, ejects drops of ink through a plurality of nozzles or orifices and toward a print medium, such as a sheet of paper, so as to print onto the print medium. Typically, the orifices are arranged in one or more columns or arrays such that properly sequenced ejection of ink from the orifices causes characters or other images to be printed upon the print medium as the printhead and the print medium are moved relative to each other.

The printhead may include one or more ink feed slots which route different colors or types of ink or fluid to fluid ejection chambers communicated with the nozzles or orifices of the printhead. Due to market forces and continuing technological improvements, the spacing or width between the ink feed slots (i.e., slot pitch) has been decreasing. This decrease in slot pitch, although increasing a number of nozzles or resolution of the printhead (i.e., nozzle density), may create a challenge in forming the ink feed slots.

### BRIEF DESCRIPTION OF THE DRAWINGS

FIG. 1 is a block diagram illustrating one embodiment of a fluid ejection system.

FIG. 2 is a schematic cross-sectional view illustrating one embodiment of a portion of a fluid ejection device.

FIGS. 3A-3J schematically illustrate one embodiment of forming a substrate for a fluid ejection device.

FIGS. 4A and 4B schematically illustrate one embodiment of a substrate for a fluid ejection device during forming of the substrate.

### DETAILED DESCRIPTION

In the following detailed description, reference is made to the accompanying drawings which form a part hereof, and in which is shown by way of illustration specific embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments of the present disclosure can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

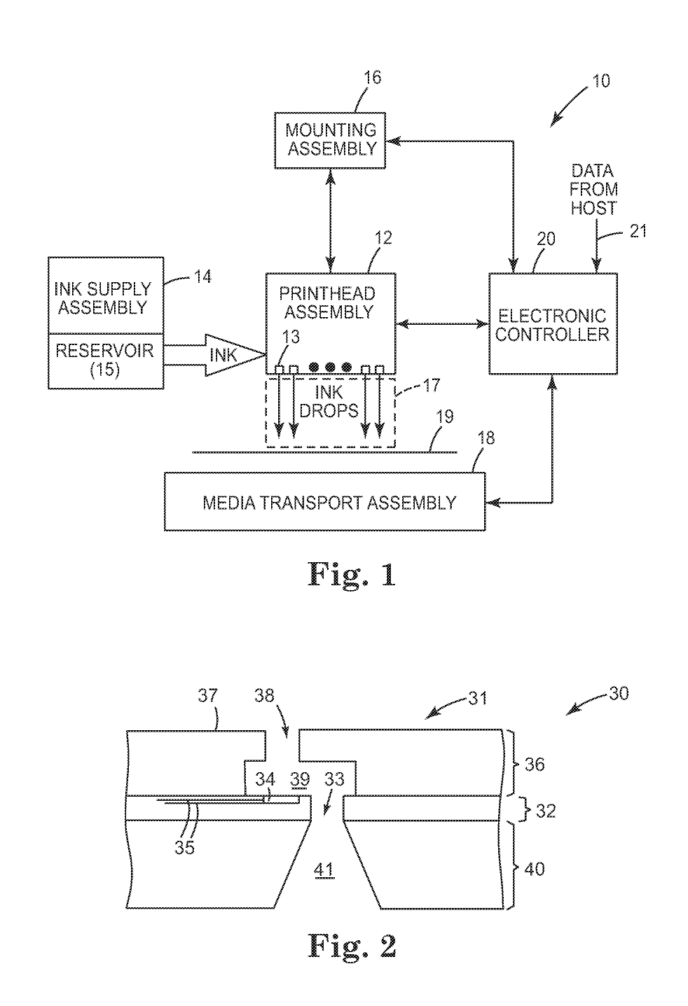

FIG. 1 illustrates one embodiment of an inkjet printing system 10. Inkjet printing system 10 constitutes one embodiment of a fluid ejection system which includes a fluid ejection assembly, such as an inkjet printhead assembly 12, and a fluid supply assembly, such as an ink supply assembly 14. In the illustrated embodiment, inkjet printing system 10 also includes a mounting assembly 16, a media transport assembly 18, and an electronic controller 20.

Inkjet printhead assembly 12, as one embodiment of a fluid ejection assembly, includes one or more printheads or fluid ejection devices which eject drops of ink or fluid through a plurality of orifices or nozzles 13. In one embodiment, the drops are directed toward a medium, such as print medium 19, so as to print onto print medium 19. Print medium 19 is any type of suitable sheet material, such as paper, card stock, transparencies, Mylar, fabric, and the like. Typically, nozzles 13 are arranged in one or more columns or arrays such that properly sequenced ejection of ink from nozzles 13 causes, in one embodiment, characters, symbols, and/or other graphics or images to be printed upon print medium 19 as inkjet printhead assembly 12 and print medium 19 are moved relative to each other.

Ink supply assembly 14, as one embodiment of a fluid supply assembly, supplies ink to inkjet printhead assembly 12 and includes a reservoir 15 for storing ink. As such, in one embodiment, ink flows from reservoir 15 to inkjet printhead assembly 12. In one embodiment, inkjet printhead assembly 12 and ink supply assembly 14 are housed together in an inkjet or fluid-jet cartridge or pen. In another embodiment, ink supply assembly 14 is separate from inkjet printhead assembly 12 and supplies ink to inkjet printhead assembly 12 through an interface connection, such as a supply tube.

Mounting assembly 16 positions inkjet printhead assembly 12 relative to media transport assembly 18 and media transport assembly 18 positions print medium 19 relative to inkjet printhead assembly 12. Thus, a print zone 17 is defined adjacent to nozzles 13 in an area between inkjet printhead assembly 12 and print medium 19. In one embodiment, inkjet printhead assembly 12 is a scanning type printhead assembly and mounting assembly 16 includes a carriage for moving inkjet printhead assembly 12 relative to media transport assembly 18. In another embodiment, inkjet printhead assembly 12 is a non-scanning type printhead assembly and mounting assembly 16 fixes inkjet printhead assembly 12 at a prescribed position relative to media transport assembly 18.

Electronic controller 20 communicates with inkjet printhead assembly 12, mounting assembly 16, and media transport assembly 18. Electronic controller 20 receives data 21 from a host system, such as a computer, and may include memory for temporarily storing data 21. Data 21 may be sent to inkjet printing system 10 along an electronic, infrared, optical or other information transfer path. Data 21 represents, for example, a document and/or file to be printed. As such, data 21 forms a print job for inkjet printing system 10 and includes one or more print job commands and/or command parameters.

In one embodiment, electronic controller 20 provides control of inkjet printhead assembly 12 including timing control for ejection of ink drops from nozzles 13. As such, electronic controller 20 defines a pattern of ejected ink drops which form characters, symbols, and/or other graphics or images on print medium 19. Timing control and, therefore, the pattern of ejected ink drops, is determined by the print job commands and/or command parameters. In one embodiment, logic and drive circuitry forming a portion of electronic controller 20 is located on inkjet printhead assembly 12. In another embodiment, logic and drive circuitry forming a portion of electronic controller 20 is located off inkjet printhead assembly 12.

FIG. 2 illustrates one embodiment of a portion of a fluid ejection device 30. Fluid ejection device 30 includes an array of drop ejecting elements 31. Drop ejecting elements 31 are formed on a substrate 40 which has a fluid (or ink) feed slot 41 formed therein. As such, fluid feed slot 41 provides a supply of fluid (or ink) to drop ejecting elements 31. Substrate 40 is formed, for example, of silicon, glass, or ceramic.

In one embodiment, each drop ejecting element 31 includes a thin-film structure 32 with a resistor 34, and an orifice/barrier layer 36. Thin-film structure 32 has a fluid (or ink) feed hole 33 formed therein which communicates with fluid feed slot 41 of substrate 40. Orifice/barrier layer 36 has a front face 37 and a nozzle opening 38 formed in front face 37. Orifice/barrier layer 36 also has a nozzle chamber 39 formed therein which communicates with nozzle opening 38 and fluid feed hole 33 of thin-film structure 32. Resistor 34 is positioned within nozzle chamber 39 and includes leads 35 which electrically couple resistor 34 to a drive signal and ground.

Thin-film structure 32 is formed, for example, by one or more passivation or insulation layers of silicon dioxide, silicon carbide, silicon nitride, tantalum, poly-silicon glass, or other material. In one embodiment, thin-film structure 32 also includes a conductive layer which defines resistor 34 and leads 35. The conductive layer is formed, for example, by aluminum, gold, tantalum, tantalum-aluminum, or other metal or metal alloy.

In one embodiment, during operation, fluid flows from fluid feed slot 41 to nozzle chamber 39 via fluid feed hole 33. Nozzle opening 38 is operatively associated with resistor 34 such that droplets of fluid are ejected from nozzle chamber 39 through nozzle opening 38 (e.g., normal to the plane of resistor 34) and toward a medium upon energization of resistor 34.

Example embodiments of fluid ejection device 30 include a thermal printhead, as previously described, a piezoelectric printhead, a flex-tensional printhead, or any other type of fluid-jet ejection device known in the art. In one embodiment, fluid ejection device 30 is a fully integrated thermal inkjet printhead.

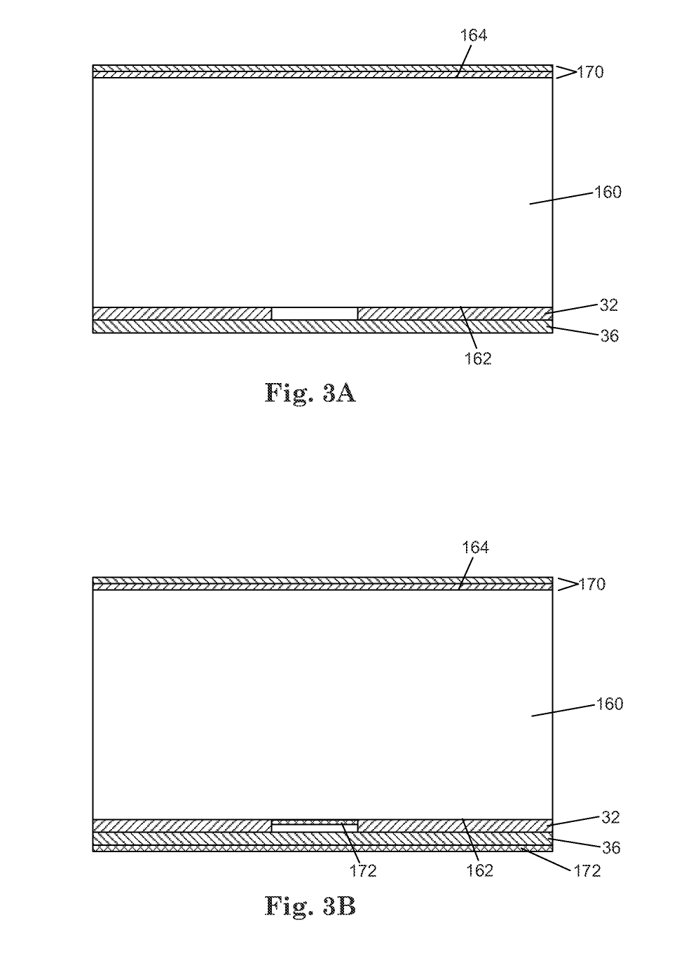

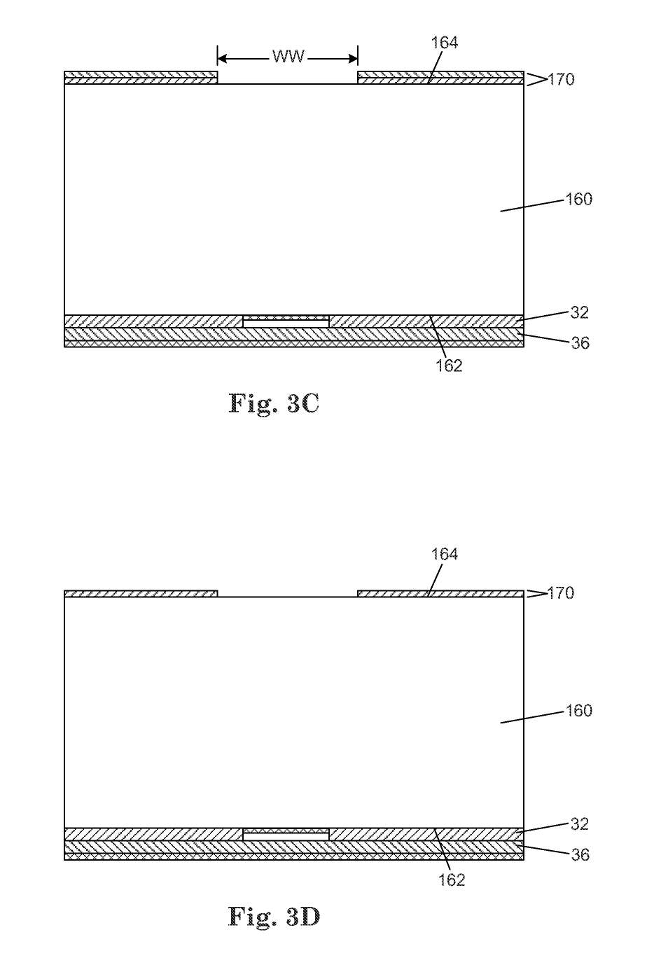

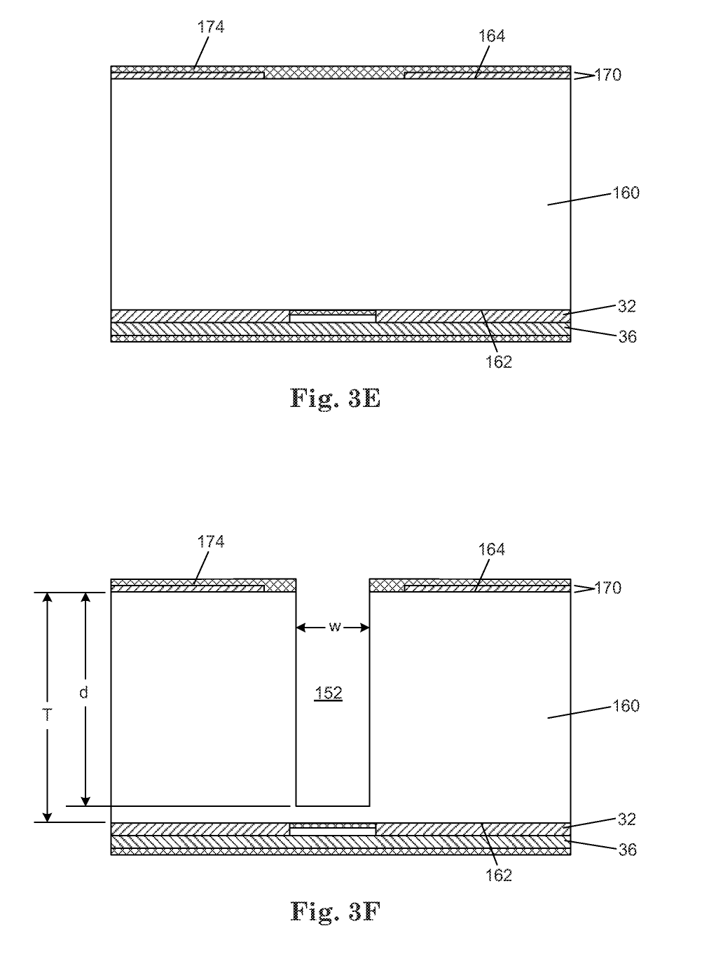

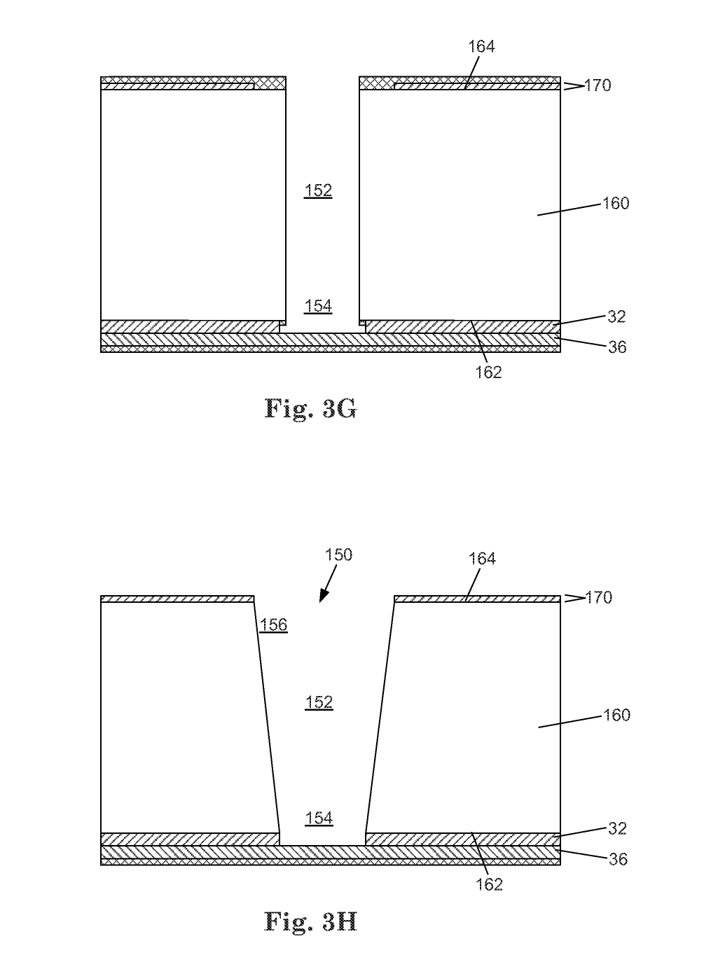

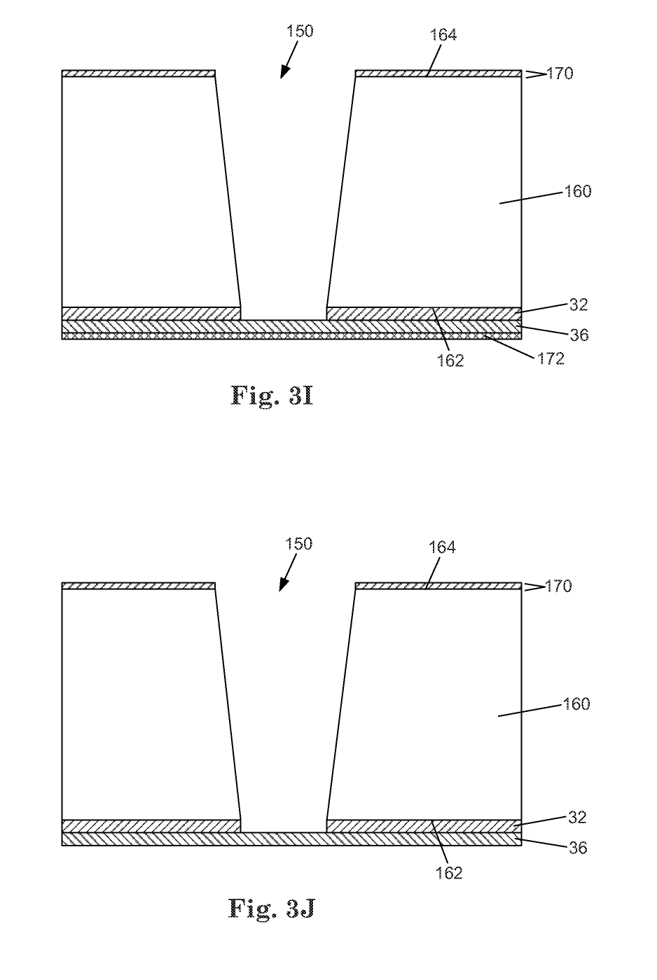

FIGS. 3A-3J illustrate one embodiment of forming an opening 150 through a substrate 160, with opening 150 and substrate 160 representing one embodiment of fluid feed slot 41 and substrate 40, respectively, of fluid ejection device 30 (FIG. 2). In one embodiment, substrate 160 is a silicon substrate and opening 150 is formed in substrate 160 as described below. Substrate 160 has a first side 162 and a second side 164. Second side 164 is opposite of first side 162 and, in one embodiment, oriented substantially parallel with first side 162. Opening 150 communicates with first side 162 and second side 164 of substrate 160 so as to provide a channel or passage through substrate 160. While only one opening 150 is illustrated as being formed in substrate 160, it is understood that any number of openings 150 may be formed in substrate 160.

In one embodiment, first side 162 forms a front side of substrate 160 and second side 164 forms a back side of substrate 160 such that fluid flows through opening 150 and, therefore, substrate 160 from the back side to the front side. Accordingly, opening 150 provides a fluidic channel or fluid (or ink) feed slot for the communication of fluid (or ink) with drop ejecting elements 31 (FIG. 2) through substrate 160.

In one embodiment, as illustrated in FIG. 3A, before opening 150 is formed through substrate 160, thin-film structure 32 including resistors 34 (FIG. 2) is formed on first side 162 of substrate 160. As described above, thin-film structure 32 includes one or more passivation or insulation layers formed, for example, of silicon dioxide, silicon carbide, silicon nitride, tantalum, poly-silicon glass, or other material. In addition, thin-film structure 32 also includes a conductive layer which defines resistors 34 and corresponding conductive paths and leads 35 (FIG. 2). The conductive layer is formed, for example, of aluminum, gold, tantalum, tantalum-aluminum, or other metal or metal alloy.

Also, as illustrated in FIG. 3A, orifice/barrier layer 36 is formed on first side 162 of substrate 160 over thin-film structure 32. Orifice/barrier layer 36 (including nozzle openings 38 and nozzle chambers 39) (FIG. 2) includes one or more layers of material compatible with the fluid (or ink) to be routed through and ejected from fluid ejection device 30. Material suitable for orifice/barrier layer 36 includes, for example, a photo-imageable polymer such as SUB. Other materials, however, may be used for orifice/barrier layer 36.

In one embodiment, as illustrated in FIG. 3A, a backside layer or stack 170 including one or more mask or protective layers is formed on second side 164 of substrate 160. One example of backside layer or stack 170 includes a multi-layer structure of poly-silicon, silicon nitride, and silicon dioxide, which acts as a stress relief oxide (SRO) between the silicon substrate and silicon nitride.

In one embodiment, as illustrated in FIG. 3B, a protective layer 172 is formed over thin-film structure 32 and orifice/barrier layer 36. One example of material suitable for protective layer 172 includes a low temperature dielectric material such as silicon nitride. Other materials or manners of protecting thin-film structure 32 and/or orifice/barrier layer 36 for subsequent processing of substrate 160 and forming of opening 150, however, may also be used.

As illustrated in FIG. 3C, backside layer or stack 170 is patterned such that select portions of backside layer or stack 170 are removed to expose areas of second side 164 of substrate 160. As such, backside layer or stack 170 defines where opening 150 is to be formed in substrate 160 at second side 164. A dimension of the exposed area of second side 164 of substrate 160 is represented by width WW. In one embodiment, backside layer or stack 170 is patterned and portions thereof removed by laser processing. Other manners of patterning backside layer or stack 170, however, maybe also be used.

In one embodiment, as illustrated in FIG. 3D, after backside layer 170 is patterned, a cleaning process is performed. The cleaning process removes debris, such as silicon debris, and in one embodiment, removes the poly-silicon material from backside layer or stack 170. In one embodiment, the cleaning process is a chemical cleaning process and uses a combination of tetra-methyl-ammonium hydroxide (TMAH) and standard cleaning solution #1 (SC1).

As illustrated in FIG. 3E, a sacrificial mask layer 174 is formed on second side 164 of substrate 160. More specifically, sacrificial mask layer 174 is formed over backside layer or stack 170 and over exposed portions or areas of second side 164 of substrate 160. In one embodiment, sacrificial mask layer 170 is a metal layer formed by deposition. One example of material suitable for sacrificial mask layer 170 includes a layer of titanium and aluminum.

In one embodiment, as illustrated in FIG. 3F, an initial or first portion 152 of opening 150 is formed in substrate 160. First portion 152 of opening 150 is formed in substrate 160 from second side 164 toward first side 162 such that a depth d of first portion 152 is less than a full thickness T of substrate 160. As such, first portion 152 of opening 150 does not extend completely through substrate 160. In addition, in one embodiment, a width w of first portion 152 of opening 150 at second side 164 of substrate 160 is less than width WW of the previously exposed area of second side 164 of substrate 160 through patterned backside layer or stack 170 (FIG. 3C). As such, first portion 152 forms a subset of opening 150 of width w. In one embodiment, first portion 152 of opening 150 is formed in substrate 160 by laser processing through sacrificial mask layer 174. In one embodiment, first portion 152 of opening 150 includes substantially parallel sidewalls from second side 164 to depth d. In another embodiment, first portion 152 of opening 150 includes sidewalls at angles greater than ninety degrees to the extent that width w of first portion 152 does not exceed width WW whereby a width of first portion 152 at depth d is less than a width of first portion 152 at second side 164.

Next, as illustrated in the embodiment of FIG. 3G, another or second portion 154 of opening 150 is formed in substrate 160. Second portion 154 of opening 150 is formed in substrate 160 from first portion 152 of opening 150 to first side 162 of substrate 160. As such, second portion 154 extends from first portion 152 to first side 162 of substrate 160 such that first portion 152 and second portion 154 together extend completely through substrate 160, so as to communicate with first side 162 and second side 164 of substrate 160. In one embodiment, second portion 154 of opening 150 is formed in substrate 160 by a dry etch process, and is performed through first portion 152 of opening 150 to first side 162 of substrate 160. In one embodiment, the dry etch process is a reactive ion etch (RIE) using a fluorine-based plasma etch such as, for example, sulfur hexafluoride.

As illustrated in the embodiment of FIG. 3H, after first portion 152 and second portion 154 of opening 150 are formed in substrate 160, another or third portion 156 of opening 150 is formed in substrate 160. In one embodiment, a maximum dimension of third portion 156 of opening 150 at second side 164 of substrate 60 is defined by width WW of the exposed area or portion of second side 164 of substrate 160 of patterned backside layer or stack 170 (FIG. 3C). In addition, sidewalls of third portion 156 converge from second side 164 of substrate 160 to first side 162 of substrate 160 such that a dimension (e.g., width) of opening 150 decreases from second side 164 to first side 162.

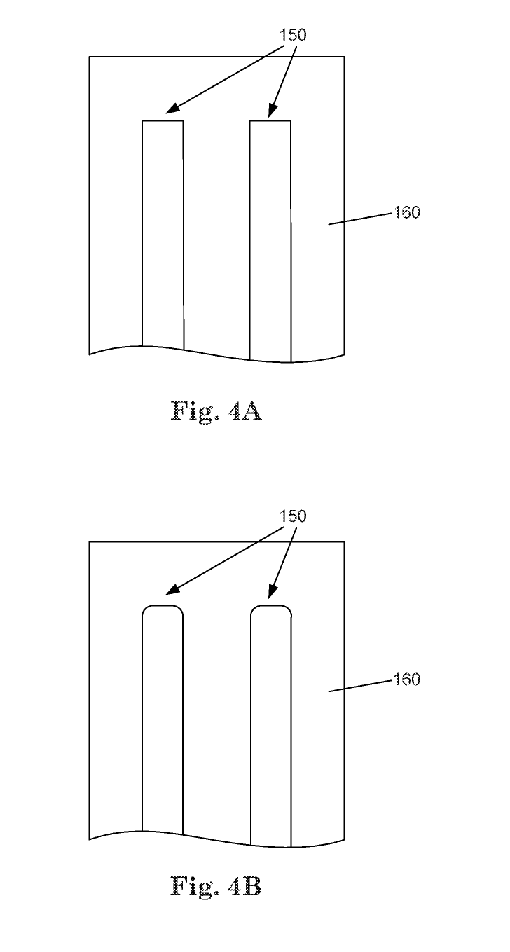

In one embodiment, third portion 156 of opening 150 is formed in substrate 160 using an anisotropic chemical etch process. More specifically, the chemical etch process is a wet etch process and uses a wet anisotropic etchant such as TMAH, potassium hydroxide (KOH), or other alkaline etchant. In addition to forming third portion 156 of opening 150, the anisotropic wet etch process also removes sacrificial mask layer 174 (FIG. 3E). With the anisotropic wet etch process, as further illustrated and described below in association with FIG. 4A, third portion 156 of opening 150 follows and is defined by crystalline planes of substrate 160 as a silicon substrate.

In one embodiment, as illustrated in FIG. 3I, after third portion 156 of opening 150 is formed in substrate 160, substrate 160 is further processed to further form opening 150 in substrate 160. In one embodiment, substrate 160 is further processed using an isotropic chemical etch process. The isotropic chemical etch process uses, for example, xenon difluoride. Performing the isotropic etch process after the anisotropic wet etch process provides stress relief at intersecting orthogonal crystalline planes of a silicon substrate of <110> orientation developed during the anisotropic wet etch process. In one embodiment, as further illustrated and described below in association with FIG. 4B, the isotropic etch process provides stress relief by smoothing or rounding (i.e., eliminating orthogonal corners of) intersecting crystalline planes of substrate 160 as a silicon substrate.

In one embodiment, as illustrated in FIG. 3J, after the isotropic etch process is completed and opening 150 is formed in substrate 160, protective layer 172 is removed from first side 162 of substrate 160. In one embodiment, protective layer 172 is removed by a buffered oxide etch (BOE).

FIGS. 4A and 4B schematically illustrate one embodiment of substrate 160 during forming of opening 150. More specifically, FIG. 4A illustrates a schematic plan view of opening 150 in substrate 160 after the anisotropic wet etch process illustrated and described in association with FIG. 3H and before the isotropic etch process illustrated and described in association with FIG. 3I. FIG. 4B, however, illustrates a schematic plan view of opening 150 in substrate 160 after the isotropic etch process illustrated and described in association with FIG. 3I.

As illustrated in FIG. 4A, after the described anisotropic wet etch process, opening 150 includes intersecting crystalline planes forming substantially ninety degree angles or corners. These corners, however, may produce areas of increased stress thereby possibly leading to cracks in substrate 160 propagating from the corners. After the described isotropic etch process, however, the angles or corners of the intersecting orthogonal crystalline planes are smoothed or rounded, as illustrated in FIG. 4B, such that the potential areas of increased stress are reduced or minimized, and strength of substrate 160 is increased.

While the above description refers to the inclusion of substrate 160 having opening 150 formed therein in an inkjet printhead assembly, it is understood that substrate 160 having opening 150 formed therein may be incorporated into other fluid ejection systems including non-printing applications or systems as well as other applications having fluidic channels through a substrate, such as medical devices or other micro electro-mechanical systems (MEMS devices). Accordingly, the methods, structures, and systems described herein are not limited to printheads, and are applicable to any slotted substrates. In addition, while the above description refers to routing fluid or ink through opening 150 of substrate 160, it is understood that any flowable material, including a liquid such as water, ink, blood, or photoresist, or flowable particles of a solid such as talcum powder or a powdered drug, or air may be fed or routed through opening 150 of substrate 160.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A method of forming a substrate for a fluid ejection device, the substrate having a first side and a second side opposite the first side, the method comprising:
forming an opening in the substrate from the second side toward the first side;
further forming the opening in the substrate to the first side;
anisotropically wet etching the substrate, including increasing the opening at the second side of the substrate and forming the opening with converging sidewalls from the second side to the first side; and
after anisotropically wet etching the substrate, isotropically etching the substrate.

2. The method of claim 1, wherein forming an opening in the substrate from the second side toward the first side comprises laser machining the substrate from the second side toward the first side.

3. The method of claim 1, wherein further forming the opening in the substrate to the first side comprises dry etching the substrate through the opening.

4. The method of claim 1, wherein anisotropically wet etching the substrate comprises anisotropically wet etching the substrate with at least one of tetra-methyl-ammonium hydroxide and potassium hydroxide.

5. The method of claim 1, wherein isotropically etching the substrate comprises isotropically etching the substrate with xenon difluoride.

6. A method of forming an opening through a substrate having a first side and a second side opposite the first side, the method comprising:
forming a portion of the opening in the substrate from the second side toward the first side;
forming another portion of the opening in the substrate from the first portion of the opening to the first side;
forming another portion of the opening in the substrate with an anisotropic wet etch of the substrate, including increasing a dimension of the opening at the second side of the substrate and converging the opening from the second side to the first side; and
forming another portion of the opening in the substrate with an isotropic etch of the substrate, including reducing angles of the opening formed through the substrate.

7. The method of claim 6, wherein forming a portion of the opening in the substrate from the second side toward the first side comprises laser machining the substrate from the second side toward the first side.

8. The method of claim 6, wherein forming another portion of the opening in the substrate from the first portion of the opening to the first side comprises dry etching the substrate through the portion of the opening.

9. The method of claim 6, wherein forming another portion of the opening in the substrate with an anisotropic wet etch of the substrate comprises anisotropically wet etching the substrate with at least one of tetra-methyl-ammonium hydroxide and potassium hydroxide.

10. The method of claim 6, wherein forming another portion of the opening in the substrate with an isotropic etch of the substrate comprises isotropically etching the substrate with xenon difluoride.

11. A method of forming a fluid ejection device, the method comprising:
providing a substrate having a first side, a second side opposite the first side, and a thin-film structure formed on the first side;
laser machining a portion of an opening into the substrate from the second side toward the first side;
dry etching another portion of the opening into the substrate from the first portion of the opening to the first side of the substrate;
anisotropically wet etching another portion of the opening through the substrate; and
thereafter, isotropically etching the opening in the substrate.

12. The method of claim 11, wherein anisotropically wet etching another portion of the opening through the substrate includes increasing the opening at the second side of the substrate and forming the opening with converging sidewalls from the second side toward the first side.

13. The method of claim 11, wherein isotropically etching the opening in the substrate includes stress relieving intersecting crystalline planes of the substrate.

14. The method of claim 11, wherein anisotropically wet etching comprises etching with at least one of tetra-methyl-ammonium hydroxide and potassium hydroxide.

15. The method of claim 11, wherein isotropically etching comprises etching with xenon difluoride.
